(19) United States
(12) Patent Application Publication
(10) Pub. No.: US 2022/0398300 A1
(43) Pub. Date: Dec. 15, 2022

(54) BAGGAGE-BASED IDENTIFICATION AND VERIFICATION SYSTEM AND METHOD

(71) Applicant: INTERNATIONAL CONSOLIDATED AIRLINES GROUP, S.A., Madrid (ES)

(72) Inventors: Glenn MORGAN, Harmondsworth, Middlesex (GB); Harvey TATE, Harmondsworth, Middlesex (GB); Daniel JOBLING, Harmondsworth, Middlesex (GB); Adam ROUNCIVELL, Harmondsworth, Middlesex (GB)

(21) Appl. No.: 17/770,189

(22) PCT Filed: Oct. 21, 2020
(86) PCT No.: PCT/EP2020/079608

§ 371 Date: Apr. 19, 2022

(30) Foreign Application Priority Data
Oct. 22, 2019 (GB) 1915258.5
Oct. 22, 2019 (GB) 1915261.0

(51) Int. Cl. G06F 21/31; G06F 3/01; H04L 9/32; H04L 9/00; G06T 19/00

(52) U.S. Cl. CPC G06F 21/31; G06F 3/011; H04L 9/3247; H04L 9/50; G06T 19/006; G06F 2221/2103; G06F 2221/2111

(57) ABSTRACT

Systems and methods for baggage identification and baggage-based user identity verification are described. In one embodiment, a user device receives a challenge message associated with a baggage item, from a server. In response, the device outputs, by an augmented or mixed reality user interface, a prompt to respond to the challenge using the baggage item. The augmented or mixed reality user interface receives a user's response to the challenge message, the response identifying a user-defined location on the baggage item. The device generates a response to the challenge message based on the identified location. The response is transmitted to the server, whereby a result is received from the server based on verification of the user-defined location communicated via the challenge response. Other embodiments are also described.

### FIELD OF THE INVENTION

This invention relates generally to a baggage handling system, and more particularly to data processing for identification of objects and/or security verification based on objects, in a baggage handling system.

### BACKGROUND

Baggage handling systems are generally known, in which a physical paper-based baggage tag is printed and affixed to an object to be ingested into the system. However, such conventional baggage tags have significant disadvantages. For example, paper-based baggage tags are prone to damage, resulting in untagged baggage items causing processing delays within the baggage handling system.

There is also a general need in conventional baggage handling systems for improved security, particularly in relation to identification and verification of baggage items and the associated owners at handover points of the system, such as physical ingestion at baggage drop off and collection at baggage reclaim.

What is desired is a solution that addresses at least some of the above issues.

### SUMMARY OF THE INVENTION

Aspects of the present invention are set out in the accompanying claims.

For example, according to one aspect, there is described a computer-implemented identity verification method, comprising a computing device performing the steps of: receiving, from a server, a challenge message associated with a baggage item; outputting, by an augmented or mixed reality user interface of the computing device in response to receiving the challenge message, a prompt to respond to the challenge using the baggage item; receiving, by the augmented or mixed reality user interface, a user's response to the challenge message, the response identifying a user-defined location on the baggage item; generating a response to the challenge message based on the identified location; and transmitting the response to the server, whereby a result is received from the server based on verification of the user-defined location communicated via the challenge response.

According to another aspect, there is described a method for registering a virtual tag of a baggage item in a baggage handling system, comprising a computing device performing the steps of: computing a first data signature based at least on measurable properties of a baggage item detected in captured image data; outputting a prompt, to an operator of the device, to modify the physical appearance of the baggage item in response to a determination that the first data signature is similar to one of a plurality of stored data signatures of other baggage items in the system; computing a second data signature based at least on measurable properties of a modified baggage item detected from subsequent captured image data; transmitting, to a server, data defining a unique virtual tag of the baggage item, the unique virtual tag including the second data signature; and receiving, from the server, a message confirming the system is updated with the unique virtual tag.

In other aspects, there are described apparatus and systems configured to perform the methods as described above. In a further aspect, a computer program is described, comprising machine readable instructions arranged to cause a programmable device to carry out the described methods.

### BRIEF DESCRIPTION OF THE DRAWINGS

There now follows, by way of example only, a detailed description of embodiments of the present invention, with references to the figures identified below.

FIG. 1 is a block diagram showing the main components of a baggage handling system according to embodiments of the invention.

FIG. 2 is a block diagram showing the main components of a virtual tag registration module in the operator device shown in FIG. 1.

FIG. 3 is a block diagram showing the main components of an object-based verification module in the operator device shown in FIG. 1.

FIG. 4 is a flow diagram illustrating exemplary steps of a virtual baggage tag registration process, performed by the virtual tag registration module of FIG. 2.

FIG. 5 is a flow diagram illustrating exemplary processing steps performed by the data signature calculation module shown in FIGS. 2 and 3, according to an embodiment.

FIG. 6, which comprises FIGS. 6A and 6B, are schematic illustrations of exemplary user interfaces output by the virtual tag registration module in the process of FIG. 4.

FIG. 7 is a flow diagram illustrating the main steps of an object-based identity verification process, performed by the object-based verification module of FIG. 3.

FIG. 8, which comprises FIGS. 8A and 8B, are schematic illustrations of exemplary user interfaces output by the object-based verification module in the process of FIG. 7.

FIG. 9 is a flow diagram illustrating the main steps of an object tracking process, performed by the operator device of FIG. 1, according to an embodiment.

FIG. 10 is a diagram of an example of a computer system on which one or more of the functions of the embodiments may be implemented.

### DESCRIPTION OF EMBODIMENTS

Specific embodiments of the invention will now be described for registering, tracking and handling an object in a baggage handling system that relates to commercial air travel, as well as identity verification based on the objects. Aspects of the invention, in particular the registration, identification and verification of a baggage/luggage item, may be applicable to other travel environments in general, such as rail, coach, automobile, and the like, as well as to any environment where an object is being transported or transferred from a source location to a destination, such as a postal or cargo delivery environment.

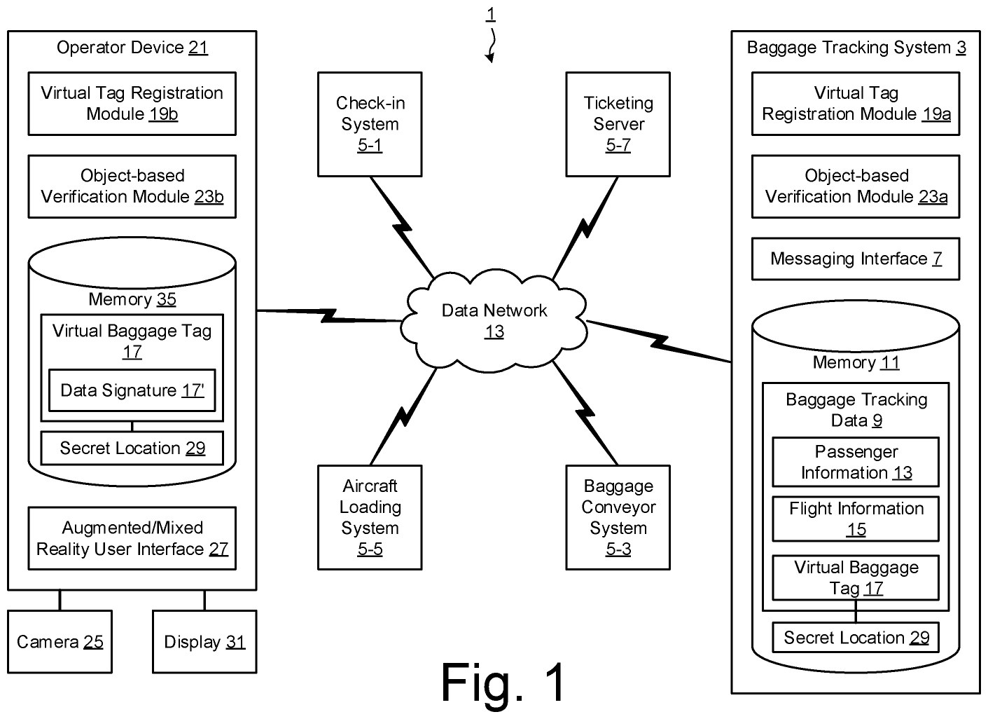

FIG. 1 illustrates a system 1 for handling baggage, according to various exemplary embodiments. The system 1 includes a baggage tracking system 3 configured to track the location of each registered baggage item in transit from a respective departure location to a destination location of a passenger travel itinerary. The baggage tracking system 3 is in data communication with other control systems 5 associated with the handling of baggage for an aircraft, for example via a messaging interface 7. Alternatively, the baggage tracking system 3 may form part of one or more of such control systems 5.

Components of the baggage handling system 1 are typically configured to communicate baggage tracking information 9 using a standard baggage message data format. The baggage tracking data 9 may be stored in a memory 11 of the baggage tracking system 3 and contain data identifying flight details 13 and passenger information 15. For example, the baggage tracking data 9 may be based on the standardised format of a conventional Baggage Source Message (BSM), which is linked to a unique index number, a license plate defined by the IATA standard that is issued by a carrier or handling agent at check-in. It will be appreciated that other standardised baggage message data formats may be implemented. In the present embodiments, the baggage information is enhanced by replacing or supplementing the conventional license plate with data defining a virtual baggage tag 17. A virtual tag registration module 19a of the baggage tracking server 3 processes requests to register a virtual baggage tag 17, for example from an operator device 21 associated with a passenger, or from a passenger and baggage check-in system 5-1. A request to register a virtual baggage tag 17 can be for the creation or enrolment of a new virtual baggage tag 17 for a baggage or luggage item that the passenger wishes to check-in to the baggage tracking system 3. The virtual tag registration module 19a may store the new virtual baggage tag 17 as a data object in the memory 11, linked to a secret location 29 defined by the associated passenger. The memory 11 may be configured as one or more databases, including data mapping the relationships between associated baggage tracking data 9, virtual baggage tags 33 and secret locations 29. This registration process may be carried out by the baggage handling system 1 instead of, or in addition to, the conventional baggage check-in process that involves generation of a unique license plate for the baggage item. An object-based verification module 23a of the baggage tracking server 3 is provided to perform data processing for security verification based on objects in a baggage handling system. In exemplary embodiments, the object-based verification module 23a processes requests to confirm the identity of a passenger and/or an associated registered baggage item, using a human challenge-response test that involves verification of the passenger's registered baggage item. For example, a request to verify a checked-in baggage item can be received from a system processing authentication of the identity of the passenger and the baggage item, prior to physical ingestion of the baggage item into the system 1.

As shown, the baggage tracking system 3 is also in data communication, via the messaging interface 7, with a ticketing server 5-7 that maintains a database of the passenger information 13. The passenger information 13 can include passenger identifiers, such as Passenger Name Records (PNR) storing personal information for a passenger and the itinerary for the passenger, or a group of passengers travelling together. The baggage tracking system 3 is also in data communication, via the messaging interface 7, with the baggage conveyor system 5-3 that conveys baggage items from a check-in system 5-1 towards an aircraft loading system 5-5 that loads of the baggage item into the cargo hold of a waiting aircraft. The baggage tracking system 3 may also be in data communication with additional control systems (not shown) via the messaging interface 7, such as departure control systems, security check-point systems, baggage sortation systems, baggage reconciliation systems, and the like. The baggage tracking system 3 may be configured to update components in the baggage handling system 1. For example, the baggage tracking system 3 may update data elements 13, 15 of the stored baggage tracking data 9 with corresponding location, security and/or status information received from one or more of the other components 5 in the baggage handling system 1. The baggage tracking system 3 may also communicate the updated baggage tracking data 9 to one or more of the other components 5, for example to trigger subsequent processes.

The baggage tracking server 3 is in data communication with an operator device 21 over a data network 13. In the present embodiment, the operator device 21 includes a virtual tag registration module 19b that communicates with the complementary virtual tag registration module 19a of the baggage tracking system 3, to process a request to register a virtual baggage tag for a physical object that the passenger will subsequently check-in to the baggage handling system 1. The operator device 21 also includes an object-based verification module 23b to process a request from the complementary object-based verification module 23a of the baggage tracking system 3, to confirm the identity of the passenger and his or her registered baggage item or items using a human challenge-response test. The operator device 21 may be configured with one of the virtual tag registration module 19b and the object-based verification module 23b. For example, an operator device 21 associated with a passenger may be configured to provide both registration and verification functionality, whereas an operator device 21 associated with a staff member at a check-in system 5-1, or a baggage handler at a baggage conveyor system 5-3 or an aircraft loading system 5-5 may be configured to provide verification functionality without a virtual tag registration module.

The virtual tag registration module 19b and the object-based verification module 23b may be provided in a software application and/or one or more webpages or browser-executable components associated with an airline service provider. The virtual tag registration process may be initiated as part of an online check-in by the passenger via the software or web page. Alternatively, the registration process may be initiated at the time of check-in at a kiosk or counter of the check-in system 5-3 in response to the passenger receiving a prompt on the operating device 21, from the virtual tag registration module 19a of the baggage tracking system 3, to launch the software application or web page including the complementary virtual tag registration module 19b. In the present embodiment, the virtual tag registration module 19b of the operator device 21 determines a data signature 17′ of the object based on the output of image processing to detect the object in image data captured by a camera 25. Preferably but not necessarily, the data signature 17′ is unique for each baggage item in the system 1, based on visible and/or measurable characteristics of the baggage item, thereby representative of a “biometric” signature of the baggage item. For example, the data signature 17′ may encode parameters of the detected shape and appearance of the baggage item. The operator device 21 also includes an augmented or mixed reality user interface 27 for the passenger to provide input defining a location 29 on the surface of the detected object as output on a display 31, for example using inputs from one or more position and/or movement sensors (not shown) of the operating device 21. Such augmented or mixed reality user interfaces are of a type that is known per se, and need not be described further. The camera 25 and display 31 may be provided as separate or integrated components of the operator device 21.

The virtual tag registration module 19b of the operator device 21 transmits data defining a new virtual baggage tag 17 to the virtual tag registration module 19a of the baggage tracking system 3, together with data identifying the secret location 29 of the virtual baggage tag 17 as affixed by the passenger to the associated baggage item via the augmented or mixed reality user interface 27. The virtual baggage tag 17 may also be stored in a memory 35 of the operator device 21, linked to the location 29 defined by the passenger. Preferably, the data identifying the defined location 29 is stored in such a way that no user can derive the secret location from the data alone. For example, the location data 29 itself can be encrypted. Data communications between the operator device 21 and the baggage tracking system 3 may also be over an established secure communication channel or session, to further encrypt the data transmitted therebetween.

The virtual tag registration module 19a of the baggage tracking system 3 may update the passenger's baggage tracking data 9 with the received virtual baggage tag 17 and communicate the updated baggage tracking data 9 to one or more of the other systems 5 in the baggage handling system 1. The operating device 21 may receive a message from the virtual tag registration module 19a of the baggage tracking system 3 to confirm that the baggage handling system 1 is updated with the registered virtual baggage tag 17.

The verification process may be initiated at the time a checked-in baggage item is to be physically separated from the passenger and ingested into the baggage handling system 1, to verify the identity of the passenger and the baggage item. For example, this could take place at a bag drop or check-in counter of an airport terminal, or at the time of pick up by a baggage collection service provider. Alternatively or additionally, the verification process may be triggered by the baggage conveyor system 5-3 or the aircraft loading system 5-5, for example in response to detection of a baggage item that requires identification to determine a subsequent handling control of the respective system. In the present embodiment, the object-based verification module 23a of the baggage tracking system 3 is configured to generate a challenge message of a human challenge-response test.

The operator device 21 receives the challenge message from the baggage tracking system 3, in the form of a request for verification based on a registered baggage item. The request may include data identifying the baggage item in question, such as a unique index of baggage tracking data 9 or the data signature 17′, which can be used to retrieve the corresponding virtual baggage tag 17 from memory 11, 35. When a request is received, the operator device 21 may prompt the operator to launch the software application or web page including the object-based verification module 23b, and initiates a verification session. The object-based verification module 23b is configured to prompt for, and receive a user's response to the challenge request. The response identifies a location on the baggage item as input by the user using the augmented or mixed reality user interface 27. The object-based verification module 23b generates and transmits a challenge response value back to the baggage tracking system 3. The challenge response value is generated from the challenge message and the location identified in the user's response, using a predefined algorithm such as a digital signing and/or hash algorithm.

The complementary object-based verification module 23a of the baggage tracking system 3 verifies the received challenge response value against a verification value generated by the object-based verification module 23a of the baggage tracking system 3, from the challenge message as sent and the secret location 29 as stored in the memory 11 of the baggage tracking system 3 using the same predefined algorithm. For example, the challenge response value and the verification value may be computed from the result of signing the challenge message with the secret location 29 using a predefined cryptographic algorithm, and/or calculation of a hash value based on the input data elements. The operator device 21 may receive a verification result from the baggage tracking system 3, and output a notification to the passenger on the display 31.

In this way, the baggage handling system 1 is configured to process computational and tamper-resistant authentication of the identity a registered object in the system 1, requiring two-fold proof from the associated passenger via a single user process flow that i) the passenger is in current possession of the physical object itself, and ii) he or she is the actual owner of the registered object, having sole knowledge of the secret location of the virtual baggage tag. The secret location 29 is never transmitted across the data network 13 during the verification session.

The operator device 21 is a computing device such as a personal computer, a laptop, a computing terminal, a smart phone, a tablet computer, or the like. The data network 13 may be any suitable data communication network or combination of networks, such as a wireless network, a local- or wide-area network including a corporate intranet or the Internet, using for example the TCP/IP protocol, or a cellular communication network such as Global System for Mobile Communications (GSM), General Packet Radio Service (GPRS), Code Division Multiple Access (CDMA), CDMA2000, Enhanced Data Rates for GSM Evolution (EDGE), Evolved High-Speed Packet Access (HSPTA+), Long Term Evolution (LTE), etc.

It should be appreciated that the baggage handling system 1 may include other components, sub-components, modules, and devices commonly found in such an environment, which are not illustrated in FIG. 1 for clarity of the description.

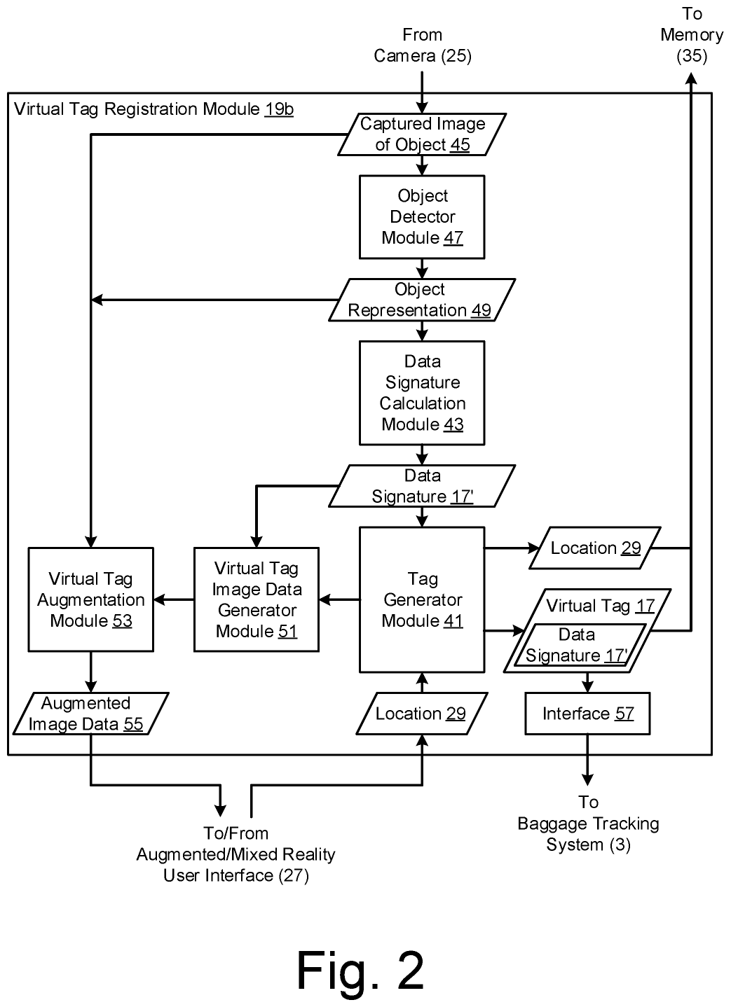

The virtual tag registration module 19b in the operator device 21 will now be described in more detail with reference to the block flow diagram of FIG. 2, using corresponding reference numerals to those of preceding figures where appropriate for corresponding elements. As shown, the virtual tag registration module 19b is configured with data and processing elements to process a request to register a virtual baggage tag 17 with the baggage tracking system 3. In this exemplary embodiment, the request is to create or enroll a virtual baggage tag 17 for a baggage item that the passenger wishes to check-in to the baggage handling system 1.

A tag generator module 41 of the virtual tag registration module 19b is configured to generate data defining a virtual baggage tag 17 for a registered baggage item in the baggage handling system 1. The virtual baggage tag 17 includes data identifying a data signature 17′ of the baggage item. The data signature 17′ may be determined by a data signature calculation module 43 based on image data 45 of the baggage item. Preferably, the image data 45 is captured by the camera 25 of the operator device 21, to ensure that the operator is in possession of the physical baggage item at the time of registration. Alternatively, the captured image data 45 may be received from a different image capture device communicatively coupled to the operator device 21.

An object detector module 47 of the virtual tag registration module 19b is configured to perform image processing on the captured image data 45 to detect the baggage item in the image. In the present exemplary embodiment, the data signature calculation module 43 determines the data signature 17′ based on measureable properties of the detected baggage item representation 49. Preferably, but not necessarily, the data signature 17′ is determined from a defined set of measureable properties that, together with associated flight information 15, uniquely identifies the corresponding baggage item. For example, the measurable properties may include one or more of physical parameters such as shape, size/dimensions, volume, and the like, and visible characteristics such as colours, patterns, surface decorations or adornments (e.g. logos, stickers, labels), and the like. Such physical parameters and/or visible characteristics may be computationally determined or detected, for example from the captured image data and/or the parameter values of the determined 3D model of the baggage item in the captured image data. Preferably, but not necessarily, one or more of the measurable properties may have an associated timestamp identifying a time that the property was measured and/or recorded.

The tag generator module 41 is also configured to receive, from the operator, a defined location 29 on the baggage item to affix the virtual baggage tag 17, using the augmented/mixed reality user interface 27. In this exemplary embodiment, a virtual tag image data generator module 51 is provided in, or called by, the virtual tag registration module 19b, to generate image data of the virtual baggage tag 17. For example, image data for a virtual baggage tag 17 may be generated based on a template image that is modified with visual elements generated from the data signature 17′. Alternatively or additionally, image data for a virtual baggage tag 17 may be generated based on user input received during the registration process. For example, the user may be prompted to select one or more images from a defined set of images or emoticons, to form a user-specific virtual baggage tag. Furthermore, in such an implementation, the selection of images or emoticons, as well as the sequence of the selections, may be used as a further data point for user verification and authentication at a subsequent stage. Previously generated image data of the virtual baggage tag 17 may be retrieved from the memory 35.

A virtual tag augmentation module 53 augments the received captured image 45 with the generated image data of the virtual baggage tag 17, at an input location on the surface of the baggage item that is visible within the display 31. The virtual tag augmentation module 53 may transform the image data of the virtual baggage tag 17 for augmentation, for example based on scale and orientation of the determined representation 49 of the baggage item detected in the captured image 45. The virtual tag augmentation module 53 outputs the augmented image data 55 to the display 31, via the augmented/mixed reality user interface 27. In this way, the operator can define the secret location 29 for the virtual baggage tag 17, for example by looking at the location of baggage item or pointing the camera of the device toward the baggage item, and inputting a command to confirm the selected location.

The tag generator module 41 receives the operator defined location 29 from the augmented/mixed reality user interface 27. The virtual tag registration module 19b of the operator device 21 transmits data defining the virtual baggage tag 17 together with the associated location data 29 to the virtual tag registration module 19a of the baggage tracking system 3 via an interface 57, for storage in the memory 11 of the baggage tracking system 3 to complete the registration process. The virtual tag registration module 19b may also store the virtual baggage tag 17 linked to the defined location 29 in the memory 35 of the operator device 21. The virtual tag registration module 19b of the operator device 21 may receive one or more notification messages from the baggage tracking system 3 to indicate registration status of the new virtual baggage tag 17.

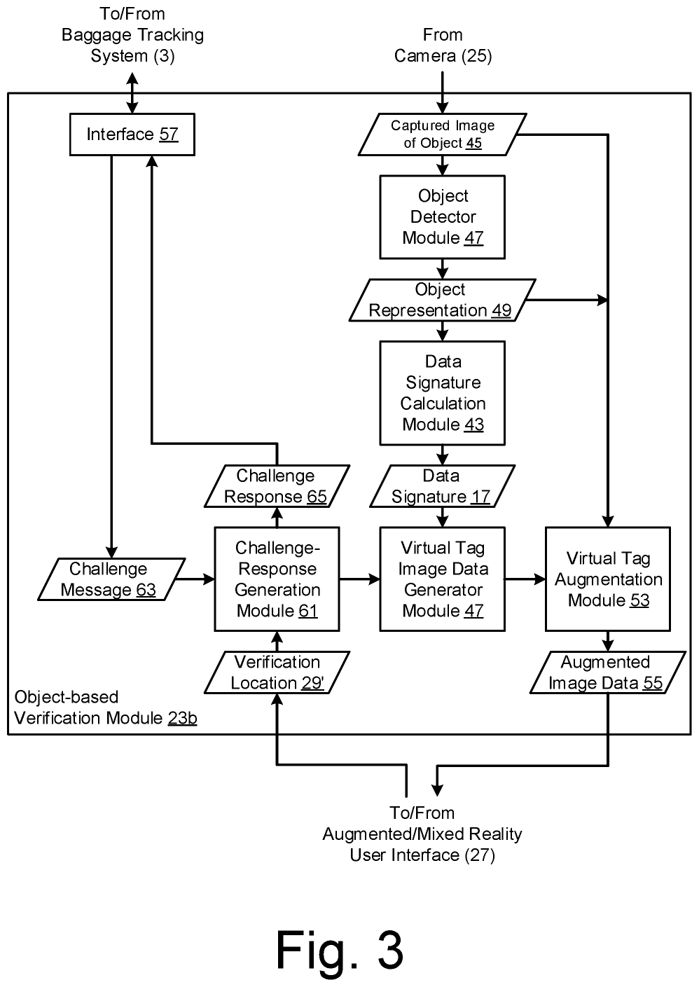

Referring now to FIG. 3, the object-based verification module 23b of the operator device 21 includes a challenge-response generation module 61 which receives a challenge message 63 from the baggage/tracking system 3 via the interface 57. In this exemplary embodiment, the challenge message 63 is received in a request to confirm the identity of the passenger's registered baggage item using a human challenge-response test. The request may include data identifying the baggage item in question, such as a unique index of baggage tracking data 9 or the data signature 17′, which can be used to retrieve the corresponding virtual baggage tag 17 from memory 11, 35. Alternatively, the request may include image data of a captured baggage item, for processing by the operator device 21 to determine the corresponding data signature 17′.

The challenge-response generation module 61 generates a challenge response 65 based on the received challenge message 63 and input from the passenger, who must be in possession of the physical baggage item in question, identifying the previously registered secret location 29 associated with that baggage item. The challenge response 65 is computed using a predefined algorithm, for example as a digital signature or hash value from the challenge message and the user input location. In this exemplary embodiment, the challenge-response generation module 61 of the object-based verification module 23b is configured to prompt for, and receive, a verification location 29′ on the baggage item, using the augmented/mixed reality user interface 27 to virtually re-affix the virtual baggage tag 17 at the previously registered location 29. The object-based verification module 23b may include or use a virtual tag image data generator 51 as described above, to re-generate the image data of the virtual baggage tag 17, for example based on the data signature 17′ determined by the data signature calculation module 43 from captured image data 45 of the baggage item. Alternatively, previously generated image data of the virtual baggage tag 17 may be retrieved from the memory 35.

The object-based verification module 23b may include or use a virtual tag augmentation module 53 as described above, to augment the received captured image 45 with the image data of the virtual baggage tag 17. The virtual tag augmentation module 53 outputs the augmented image data 55 to the display 31 and receives input from the passenger of the verification location 29′, via the augmented/mixed reality user interface 27. As discussed above, the image data 45 is preferably captured by the camera 25 of the operator device 21, to ensure that the passenger is in possession of the physical baggage item at the time of verification. The challenge-response generation module 61 returns the generated challenge response 65 to the baggage tracking system 3 via the interface 57, as a response to the received request. The challenge-response generation module 61 of the operator device 21 may receive one or more notification messages from the baggage tracking system 3 to indicate verification status of the baggage item.

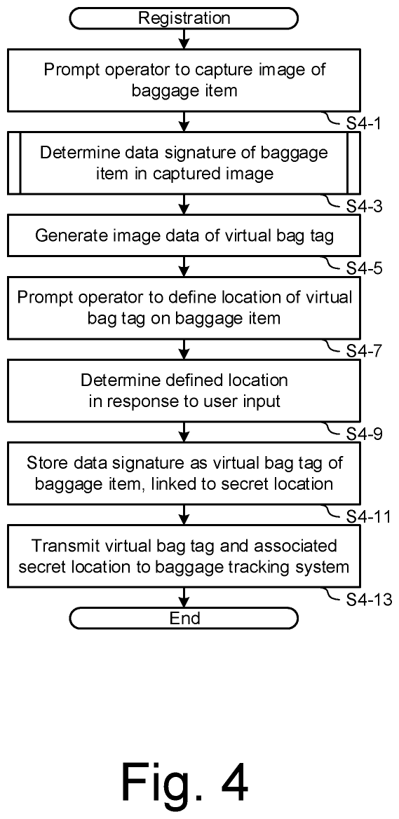

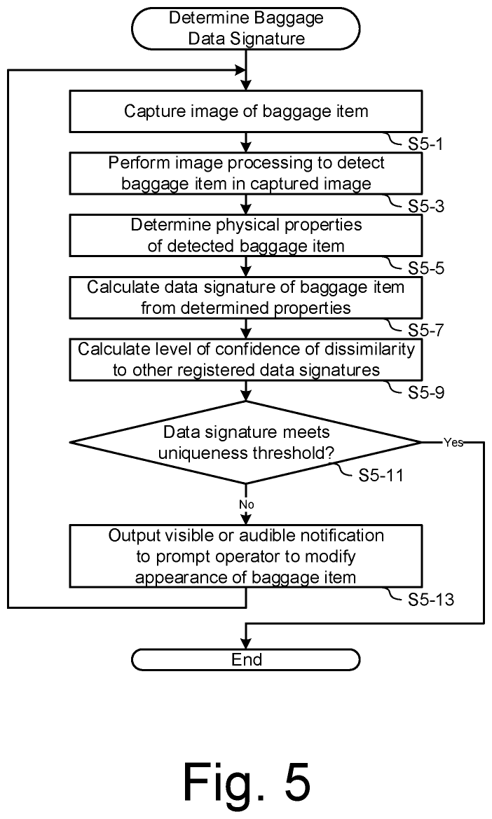

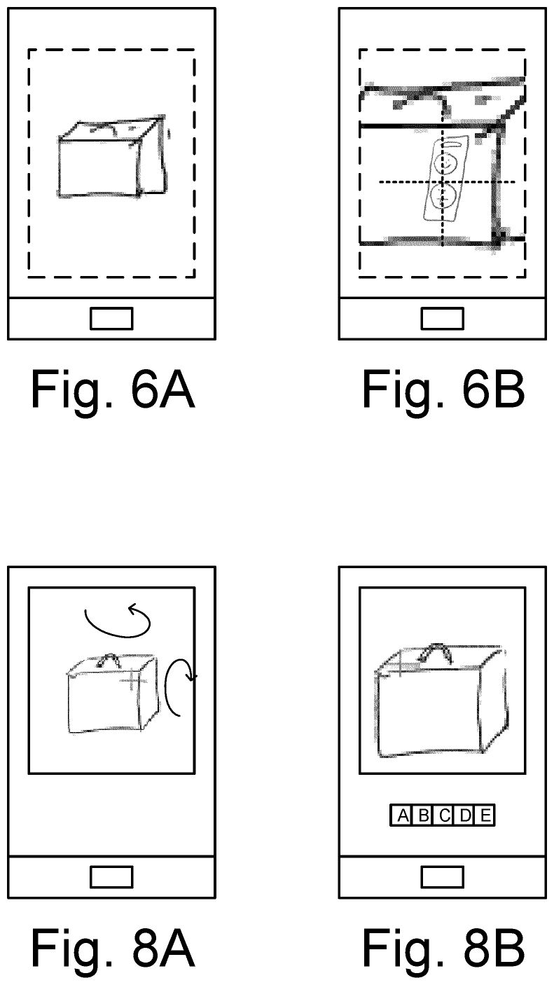

A brief description has been given above of the components forming part of the virtual tag registration module 19b of the operator device 21. A more detailed description of the operation of these components will now be given with reference to the flow diagram of FIGS. 4 and 5, for an exemplary embodiment of a computer-implemented virtual tag registration process, using an operator device 21 configured with a virtual tag registration module 19b. The registration process may be initiated in response to user selection of a registration option in the software application or web page including the virtual tag registration module 19b. Reference is also made to FIG. 6, which comprises FIGS. 6A to 6B, showing schematic illustrations of exemplary user interfaces output by the virtual tag registration module 19b.

As shown in FIG. 4, the process begins at step S4-1 where the tag generator module 41 prompts the operator to capture an image of the baggage item for registration of a new virtual baggage tag 17. Preferably, the operator is the passenger associated with the baggage item. At step S4-3, the data signature calculation module 43 determines a data signature of the baggage item in the captured image 45. FIG. 5 shows in more detail the processing steps of the data signature calculation module 43 to determine a data signature of a baggage item. At step S5-1, the camera 25 captures image data 45 of the baggage item, as schematically illustrated in the exemplary user interface of FIG. 6A. The image data 45 may include a sequence of individual images automatically captured by the camera 25 while the operator is directing the camera 25 at the baggage item. Alternatively, the camera 25 may be configured to capture an image in response to user input, for example pressing a button. Each captured image may include time-stamp information of the date and time that image was captured.

At step S5-3, the object detection module 47 performs image processing on the captured image data 45 to detect a representation 49 of the baggage item in the captured image 45. Purely by way of example, the object detector module 47 may implement an image processing algorithm that performs edge detection based on pixel data in the captured image 45 to identify the size, location and orientation of a 3D model representation 49 of the baggage item detected in the captured image 45. As yet another example, the object detector module 47 may implement a trained neural network model for baggage recognition, to output a bounding box representation 49 around a baggage item detected based on input image data. Alternatively or additionally, the operating device 21 may include one or more devices to obtain the representation 49 of the baggage item, such as a laser-based or x-ray scanner to provide an output representation 49 that includes shape and/or dimension information of the baggage item. The object detector module 47 may receive further measured properties of the detected baggage item from one or more external devices to supplement the object representation 49, such as weight or density measurements.

At step S5-5, the data signature calculation module 43 receives the baggage item representation 49 output by the object detector module 47, and determines physical properties of the detected baggage item, based on the determined representation 49. For example, the height, width and depth of the detected baggage item may be defined based on the size parameters of a 3D model representation 49 output by the object detection module 47. Additionally, visible characteristics of the detected baggage item such as colours, patterns, surface decorations or adornments, deformities, and the like, may be defined based on pixel values of the surfaces of the 3D model representation 49 derived from the captured image data 45. At step S5-7, the data signature calculation module 43 calculates a data signature 17′ of the baggage item, based at least on the physical properties of the detected baggage item as determined at step S5-5. The data signature 17′ may be structured set of data values associated with respective measurable properties of the detected baggage item. Alternatively or additionally, the data signature 17′ may be computed from the values of the measurable physical properties using a predefined algorithm, for example by computing a unique hash value from a defined set of measurable properties.

Optionally, the data signature calculation module 43 may be configured to determine if the data signature 17′ calculated at step S5-7 is identical or similar to another data signature 17′ as previously registered and stored at the baggage tracking system 3. For example, at step S5-9, the data signature calculation module 43 may transmit a request to the baggage tracking system 3 to check that the calculated data signature 17′ is unique. In response to the received request including the calculated data signature 17′, the baggage tracking system 3 may compare the received data signature 17′ to all of the virtual baggage tags 17 stored in memory 11, and calculate a value representing a level of confidence of dissimilarity to other registered data signatures 17′. The baggage handling system 3 may determine if the calculated value meets a predefined minimum threshold for dissimilarity, and if so, may return a response indicating that the calculated data signature 17′ meets the system-wide uniqueness threshold. At step S5-11, the data signature calculation module 43 may determine from the received response if the calculated data signature 17′ for the baggage item meets the uniqueness threshold, and if not, may output a visible, audible and/or haptic notification to prompt the operator to modify the appearance of the baggage item, at step S5-13. Processing then returns to step S5-1 where the operating device 21 repeats the process of determining a new data signature 17′ based on captured image data 45 of the modified baggage item, until the data signature calculation module 43 determines, at step S5-11, that the calculated data signature 17′ is unique.

Returning to FIG. 4, at step S4-5, the virtual tag image data generator module 51 generates image data for the virtual baggage tag 17. For example, the generated image data may take the form of a replica of a conventional paper tag with a bar code that encodes the unique identifier of the associated baggage tracking data 9. At step S4-7, the tag generator module 41 prompts the operator to define a location of the virtual baggage tag 17 on the baggage item in the captured image 45. The operator may the camera 25 closer to the baggage item and/or interact with the user interface to zoom in and out of the captured image data, in order to define a more precise location for the virtual baggage tag 17. In an exemplary implementation, the virtual tag augmentation module 53 may perform image data processing to augment the received captured image 45 with the generated image data of the virtual baggage tag 17, as schematically illustrated in the exemplary user interface of FIG. 6B. For example, pixel values of the detected baggage item at a location in the middle of the captured image 45 may be replaced or combined with pixel values of the generated image data of the virtual baggage tag 17. The middle of the captured image 45 represents a focal point of the operator's view through the augmented/mixed reality user interface 27.

The augmented/mixed reality user interface 27 may prompt the operator to move the device 21 and/or camera 25 to adjust the input location for virtual affixing of the virtual tag of the virtual baggage tag 17 to a surface of the baggage item. As the operator moves the device 21, the augmented/mixed reality user interface 27 may continually update coordinates of the object representation 49, for example based on inputs from position and/or movement sensors of the operator device 21. The virtual tag augmentation module 53 may transform the image data of the virtual baggage tag 17 for augmentation, for example based on scale and orientation of the determined representation 49 of the baggage item detected in the captured image 45. The virtual tag augmentation module 53 outputs the augmented image data 55 to the display 31 and awaits user input of a command to confirm the secret location 29 for the virtual baggage tag 17.

At step S4-9, the tag generator module 41 determines the operator defined location 29 in response to user input received via the augmented/mixed reality user interface 27. The defined location 29 may be stored in any data format. For example, the location 29 may be a 3D coordinate relative to the determined 3D model of the baggage item. Alternatively, the location 29 may be an identifier of one of a plurality of regions defined relative to the determined 3D model of the baggage item, such as upper right quadrant of front face, lower left quadrant of right side, inside upper compartment, etc. Alternatively, the location 29 may be defined as a coordinate within the baggage item.

At step S4-11, the tag generator module 41 stores the data signature determined at step S4-3 as the virtual baggage tag 17 of the baggage item in the memory 35, linked to the location 29 defined by the operator determined at step S4-9. The tag generator module 41 may encrypt the location data 29 before storing the data in memory 35. The tag generator module 41 may also store the generated image data of the virtual baggage tag 17 in the memory 35. The stored virtual baggage tag 17 may also include data linking to the associated passenger information 13. At step S4-13, the tag generator module 41 of the virtual tag registration module 19b transmits the virtual baggage tag 17 and associated location data 29 to the complementary virtual tag registration module 19a of the baggage tracking system 3, for example of a secure communication channel that is established between the components. The baggage tracking system 3 may store the received virtual baggage tag 17 and associated location data 29 in memory 11. The received virtual baggage tag 17 may be stored as part of the baggage tracking data 9 of the associated baggage item, such that the other components 5 in the baggage handling system 1 will subsequently receive an updated version of the baggage tracking data 9 including the virtual baggage tag 17.

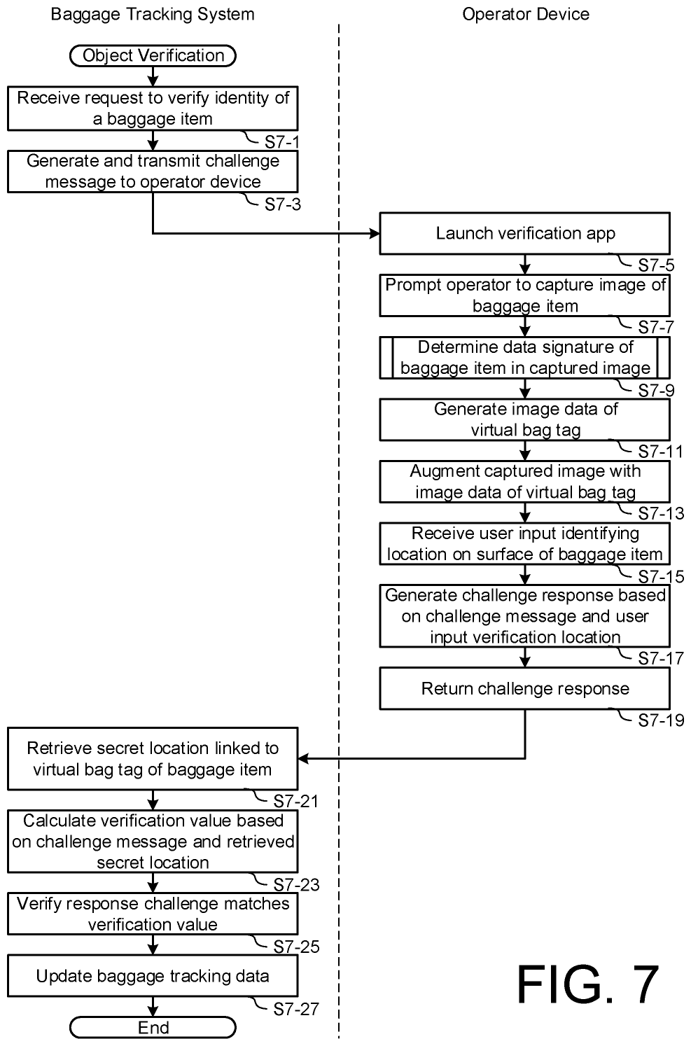

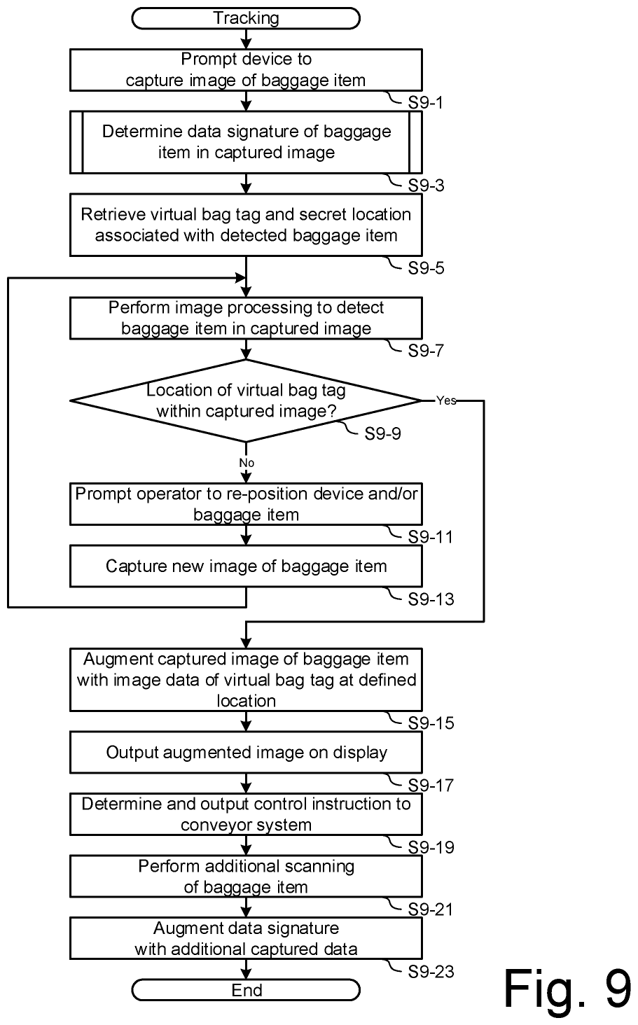

A brief description has been given above of the components forming part of the object-based verification module 23b of the operator device 21. A more detailed description of the operation of these components will now be given with reference to the flow diagram of FIG. 7, for an exemplary embodiment of a computer-implemented baggage-based identification and verification process, using an operator device 21 and baggage tracking system 3 configured with complementary object-based verification modules 23. Reference is also made to FIG. 8, which comprises FIGS. 8A and 8B, showing schematic illustrations of exemplary user interfaces output by the object-based verification module 23b of the operator device 21. The baggage identification and verification process may be initiated in response to user selection of an identification and/or verification option in the software application or web page including the object-based verification module 23b, or in response to a request received from any one of the other components 5 of the baggage handling system 1, such as the check-in system 5-1 to verify a checked-in baggage item prior to physical ingestion of the authenticated baggage item into the baggage handling system 1.

As shown, the process begins at step S7-1, where the object-based verification module 23a of the baggage tracking system 3 may receive a request to verify the identity of a checked-in baggage item that is registered with the baggage handling system 1. In response, at step S7-3, the object-based verification module 23a of the baggage handling system 3 generates and transmits a challenge message 63 of a human challenge-response test to the operator device 21, in the form of a request for verification of an identified baggage item. The challenge message 63 can include data that is generated or selected pseudo-randomly, such as a string of random alphanumeric symbols or pixel data of an image. The request includes data identifying the baggage item in question, such as a unique index of baggage tracking data 9 and/or details of the associated flight.

At step S7-5, the operator device 21 may launch the software application or web page including the object-based verification module 23b, in response to receiving the received request and challenge message 63 from the baggage handling server 3. Alternatively, the operating system of the operator device 21 may output a notification message or prompt for the operator to load the object-based verification module 23b. At step S7-7, the challenge-response generation module 61 of the object-based verification module 23b may prompt the operator to capture an image 45 of the baggage item. At step S7-9, the object-based verification module 23b uses the data signature calculation module 43 to determine a data signature 23 of the baggage item in a captured image 45, in the same way as discussed above with reference to step S4-3. At step S7-11, the object-based verification module 23b may use the virtual tag image data generator module 51 to generate image data for the virtual baggage tag 17, in the same way as discussed above with reference to step S4-5. Alternatively, image data of the virtual baggage tag 33 may be retrieved from memory 35 of the operator device 21 or received from the baggage handling server 3. At step S7-13, the object-based verification module 23b may use the virtual tag augmentation module 53 to augment the captured image 45 with the image data of virtual baggage tag 17, in the same way as discussed above with reference to step S4-7. For example, the virtual tag augmentation module 53 may output the augmented image data 55 to the display 31, using the augmented/mixed reality user interface 27, and prompt the operator to virtually affix the virtual baggage tag 33 at the previously registered location 29 using the augmented/mixed reality user interface 27, similar to the exemplary user interface of FIG. 6A. In an alternative implementation, the object-based verification module 23b may be configured to output an image of the baggage item in question, such as a rendered image of a 3D model of the baggage item, and prompt the operator to input the previously registered location on the output image of the baggage item, as schematically illustrated by the cross in the exemplary user interface of FIG. 8A. It will be appreciated that the object-based verification module 23b in such an implementation may be further configured to enable the operator to interact with the rendered image of the 3D model, for example to rotate, pan and zoom about the model in order to precisely define the user input verification location 29′. The object-based verification module 23b may be additionally configured to prompt the operator to input a sequence of selected images or emoticons, as schematically illustrated in the exemplary user interface of FIG. 8B, and to verify the input against the sequence of selected images or emoticons as previously registered with the baggage tracking system 3.

At step S7-15, the challenge-response generation module 61 receives data identifying the user input verification location 29′ on the surface of the detected baggage item in the captured image 45. At step S7-17, the challenge-response generation module 61 generates a challenge response 65 based on the received challenge message 63 and the verification location 29′ input by the operator at step S7-15. For example, a digital signature value may be computed from the result of signing the challenge message 63 with the verification location 29′ using a predefined cryptographic signing algorithm. Alternatively or additionally, a hash value may be computed from the challenge message 63 and the verification location 29′ using any hash function, such as MD4 and MD5, Secure Hash Algorithms, or the like.

At step S7-19, the challenge-response generation module 61 returns the generated challenge response 65 to the baggage tracking system 3 via the interface 57, as a response to the received request. In response to receiving the challenge response 65, the object-based verification module 23a of the baggage tracking system 3 retrieves, from the memory 11, the secret location 29 linked to the virtual baggage tag 33 of the baggage item to be identified and authenticated, at step S7-21. The challenge response 65 may include an identifier of the challenge message request as received from the baggage handling system 3. At step S7-23, the object-based verification module 23a of the baggage handling system 3 calculates a verification value, based on the challenge message 63 and the retrieved secret location 29. The response value and the verification value will be computed using the same predefined algorithm. At step S7-25, the object-based verification module 23a of the baggage handling system 3 verifies that the verification value calculated at step S7-23 matches the challenge response 65 as received from the operator device 21. In this way, passengers use their respective operating devices 21 to prove to the baggage handling system 3 that they are in physical possession of the baggage item in question, and that they are the actual owner or authorised handler of that baggage item, by cryptographically transmitting knowledge of the secret location 29 of the virtual baggage tag 17, without transmission of the actual location information itself.

Accordingly, in response to verifying that the challenge response and verification values match, the object-based verification module 23a of the baggage tracking system 3 may update the baggage tracking data 9 to include information indicating that the identity of the associated checked-in baggage item has been verified with the passenger. The object-based verification module 23a of the baggage tracking system 3 may generate and transmit a data message to the operator device 21 to indicate verification status of the baggage item.

FIG. 9 is a flow diagram of a computer-implemented process for tracking the location of an object in a baggage handling system using an operator device 21 according to an exemplary alternative embodiment. The tracking process may be initiated by one or more systems 5 of the baggage handling system 1, in the course of tracking the location of each registered baggage item in transit to a respective destination location. In the present embodiment, the process is initiated in response to an operator launching the software application or web page including a modified object-based verification module 23b that is configured to process a request to identify a baggage item having a registered virtual baggage tag 17 in the baggage handling system. For example, the tracking process may be implemented as part of operator-assisted routing control in the baggage conveyor system 5-3, or at the point a baggage item is being transferred for handling by the aircraft loading system 5-5. As another example, the tracking process may be implemented in the course of collection of a baggage item from a baggage reclaim area of the conveyor system 5-3, for example by a passenger wishing to verify that he or she is picking up the correct baggage item.

As shown, the process begins at step S9-1 where the object-based verification module 23b prompts the operator to capture an image of a baggage item. At step S9-3, the object-based verification module 23b uses a data signature calculation module 43 to determine a data signature of the baggage item in the captured image 45, as discussed above with reference to step S4-3 and FIG. 5. At step S9-5, the object-based verification module 23b determines and retrieves the virtual baggage tag 17 having the matching data signature data 17′, as well as the corresponding secret location 29 linked to the determined virtual baggage tag 17. The virtual baggage tag 17 and location 29 data may be retrieved from the memory 35 of the operator device 21.

Alternatively, the object-based verification module 23b may be configured to request and receive the virtual baggage tag 17 and linked location 29 from the baggage tracking system 3, over a secure data communication session. The data signature 17′ determined at step S9-3 may be used as a search index to retrieve the corresponding virtual baggage tag 17 from a database stored in memory 11 of the baggage tracking system 3. The object-based verification module 23b and/or the baggage tracking system 3 may be configured to resolve multiple search results of candidate matching virtual baggage tags 33, where the data signature 17′ determined at step S9-3 is similar or identical to more than one stored data signature 17′. For example, the object-based verification module 23b may compare a time stamp of the captured image 45 against a known or calculated time window corresponding to the trajectory of the baggage item of each candidate search result based on associated flight details. This time-based comparison can be used to filter out candidate virtual baggage tags that are associated with baggage items that should not be present at the location of the operator device 21, at the time of processing the request to identify a baggage item.

At step S9-7, the object-based verification module 23b uses the object detector module 47 to perform image processing on the captured image data 45 to detect a representation 49 of the baggage item in the image, as discussed above. At step S9-9, the object-based verification module 23b may determine if the defined location 29 is present in a surface of the detected representation 49 that is visible within the output window of the display 31. The specific computation steps will depend on the data format of the location data 29. For example, if the location 29 is defined as a 3D coordinate relative to a 3D model of the baggage item, the determination at step S9-9 may be computed by mapping the 3D coordinate of the virtual baggage tag to the viewing window, and comparing the mapped coordinate to display bounds of the viewing window to determine if the location 29 is within the captured image. A similar mapping and comparison may be performed in an alternative example where the location 29 is defined as a defined region or area of the surface of the baggage item, instead of a single coordinate.

When the object-based verification module 23b determines at step S9-9 that the location 29 of the virtual baggage tag 17 is not within the captured image 45, then at step S9-11, the object-based verification module 23b may prompt the operator to re-position the device 21, the camera 25 and/or the baggage item itself, such that the secret location 29 is in view. For example, the object-based verification module 23b may use the augmented/mixed reality user interface 27 to prompt the operator to move the device 21 and/or camera 25 to adjust the input location for virtual affixing of the virtual tag of the virtual baggage tag 17 to a surface of the baggage item, as discussed above. At step S9-13, the object-based verification module 23b captures a new image of the baggage item, before returning to step S9-7 to perform image processing to detect the baggage item in the new captured image 45.

On the other hand, when it is determined at step S9-9 that the defined location 29 of the retrieved virtual baggage tag 17 is visible in the captured image data 45 of the baggage item, then at step S9-15, the object-based verification module 23b uses the virtual tag augmentation module 53 to augment the received captured image 45 with image data of the virtual baggage tag 17, as discussed above. The image data of the virtual baggage tag 17 may be generated by the virtual tag image data generator module 47, for example based on the data signature 17′ of the baggage item determined at step S9-3. Alternatively, the image data of the virtual baggage tag 17 may be retrieved from memory 35 of the operating device 21 or received from the baggage tracking system 3 as part of the virtual baggage tag 17. At step S9-17, the object-based verification module 23b outputs the augmented image data 55 to the display 31, via the augmented/mixed reality user interface 27.

Additionally, the image data of the virtual baggage tag 17 may encode information that can be decoded to identify the associated baggage item. For example, the image data of the virtual baggage tag 17 may include a conventional machine readable barcode encoding the unique license plate of the baggage tracking data 9 of the baggage item. In this way, the object-based verification module 23b can be configured to use a conventional barcode reader and related baggage tracking data processing modules to scan and process the augmented image data 55 as output on the display 31, for example to determine and output an operating instruction to control the baggage conveyor system 5-3, at step S9-19.

As a further possible modification, the operator device 21 may be configured to perform additional scanning of the baggage item using one or more scanning modules or devices (not shown), at step S9-21. Alternatively, the operator device 21 may receive the results of additional scanning from one or more external scanning systems (not shown). At step S9-23, the object-based verification module 23b may be further configured to augment the data signature 17′ of the virtual baggage tag 17 based on the additional captured data, to enhance the uniqueness and verifiability of the baggage item based on the updated virtual baggage tag 17. The updated virtual baggage tag 17 may be transmitted to the baggage tracking system 3 to replace of the previous virtual baggage tag 17 stored in memory 11. The baggage tracking system 3 may subsequently communicate the corresponding updated baggage tracking data 9 to one or more of the other components 5.

### Example Computer System Implementation

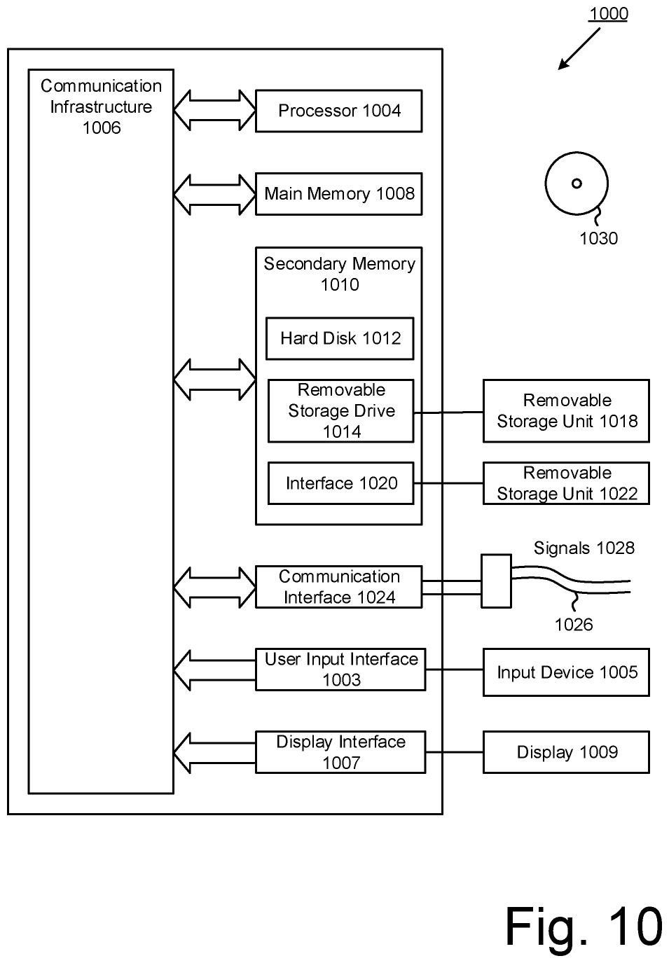

FIG. 10 illustrates an example computer system 1000 in which the present invention, or portions thereof, can be implemented as computer-readable code to program processing components of the computer system 1000. For example, the methods illustrated by the flowchart of FIGS. 4, 5, 7 and/or 9 can be implemented in system 1000. The operator device 21 and the baggage handling system 3 of FIGS. 1, 2 and/or 3 can also be implemented in respective systems 1000. Various embodiments of the invention are described in terms of this example computer system 1000. After reading this description, it will become apparent to a person skilled in the relevant art how to implement the invention using other computer systems and/or computer architectures.

Computer system 1000 includes one or more processors, such as processor 1004. Processor 1004 can be a special purpose or a general-purpose processor. Processor 1004 is connected to a communication infrastructure 1006 (for example, a bus, or network). Computer system 1000 also includes a user input interface 1003 connected to one or more input device(s) 1005 and a display interface 1007 connected to one or more display(s) 1009, which may be integrated input and display components. Input devices 1005 may include, for example, a pointing device such as a mouse or touchpad, a keyboard, a touchscreen such as a resistive or capacitive touchscreen, etc. According to the embodiments of the operator device 21 described above, computer display 1009 corresponding to display 31, in conjunction with display interface 1007, can be used to display the augmented/mixed reality UI 27, and receive user input from the augmented/mixed reality UI 27 through the user input interface 1003.

Computer system 1000 also includes a main memory 1008, preferably random access memory (RAM), and may also include a secondary memory 1010. Secondary memory 1010 may include, for example, a hard disk drive 1012, a removable storage drive 1014, flash memory, a memory stick, and/or any similar non-volatile storage mechanism. Removable storage drive 1014 may comprise a floppy disk drive, a magnetic tape drive, an optical disk drive, a flash memory, or the like. The removable storage drive 1014 reads from and/or writes to a removable storage unit 1018 in a well-known manner. Removable storage unit 1018 may comprise a floppy disk, magnetic tape, optical disk, etc. which is read by and written to by removable storage drive 1014. As will be appreciated by persons skilled in the relevant art(s), removable storage unit 1018 includes a non-transitory computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

Computer system 1000 may also include a communications interface 1024, for example corresponding to interfaces 7, 57. Communications interface 1024 allows data to be transferred between computer system 1000 and external devices, for example as signals 1028 over a communication channel 1026. Communications interface 1024 may include a modem, a network interface (such as an Ethernet card), a communications port, a PCMCIA slot and card, or the like.

Various aspects of the present invention can be implemented by software and/or firmware (also called computer programs, instructions or computer control logic) to program programmable hardware, or hardware including special-purpose hardwired circuits such as application-specific integrated circuits (ASICs), programmable logic devices (PLDs), field-programmable gate arrays (FPGAs), etc. of the computer system 1000, or a combination thereof. Computer programs for use in implementing the techniques introduced here may be stored on a machine-readable storage medium and may be executed by one or more general-purpose or special-purpose programmable microprocessors. The terms “computer program medium”, “non-transitory computer readable medium” and “computer usable medium” introduced herein can generally refer to media such as removable storage unit 1018, removable storage unit 1022, and a hard disk installed in hard disk drive 1012. Computer program medium, computer readable storage medium, and computer usable medium can also refer to memories, such as main memory 1008 and secondary memory 1010, which can be memory semiconductors (e.g. DRAMs, etc.). These computer program products are means for providing software to computer system 1000.

Computer programs are stored in main memory 1008 and/or secondary memory 1010. Computer programs may also be received via communications interface 1024. Such computer programs, when executed, enable computer system 1000 to implement the present invention as described herein. In particular, the computer programs, when executed, enable processor 1004 to implement the processes of the present invention, such as the steps in the methods illustrated by the flowchart of FIGS. 4, 5, 6 and/or 7, or the operator device 21 or the baggage handling system 3 of FIGS. 1, 2 and/or 3, as described above. Accordingly, such computer programs represent controllers of the computer system 1000. Where the invention is implemented using software, the software may be stored in a computer program product and loaded into computer system 1000 using removable storage drive 1014, interface 1020, hard drive 1012, or communications interface 1024.

Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage device, etc.), and communication mediums (e.g., wired and wireless communications networks, local area networks, wide area networks, intranets, etc.).

### Alternative Embodiments

It will be understood that embodiments of the present invention are described herein by way of example only, and that various changes and modifications may be made without departing from the scope of the invention.

For example, in the embodiments above, a data signature is determined based on measureable properties of a baggage item representation detected from captured image data. As those skilled in the art will appreciate, the detectable properties may further include visible characteristics of the baggage item such as materials, damage, deformities, baggage feature locations (e.g. zip, pocket, strap, wheels, locks), residual user data fingerprints, footprint of the baggage item when opened, and the like. Additionally, the detectable properties may include non-visible characteristics such as weight, centre of gravity, density, x-ray imaging parameters, microdots, vibration signature, sonar response, moisture, odour intensity or composition, radiation, and the like. Such non-visible characteristics may be computationally determined or detected from data captured by one or more measurement devices such as scales, x-ray scanners, CT scanners, mass spectrometers, and the like. The measurement devices may be provided at scanning and security checkpoints of the baggage handling system that process the checked baggage item after ingestion into the system. As a further modification, the visible characteristics and/or captured data may comprise one or more time stamps indicative of temporal changes to the respective one or more parameters of the detected baggage item.

In yet a further alternative implementation, the measurable properties of a baggage item may further include observable parameters that are determined for example from video data capturing movement of the baggage item, such as movement direction (e.g. when the baggage item is pushed along a predefined path at a constant force), a coefficient of friction, wheel prints (e.g. when the baggage item is rolled through ink), and the like. Alternatively or additionally, the measurable properties may also include the assigned data parameters of the baggage item, such as an item serial, batch number, country of production, and the like, which may be communicated from a data storage element embedded in the baggage item, to the the data signature calculation module. Further, the measurable properties of a baggage item may include a predicted location parameter, which is computed based on a present known location within the baggage handling system and/or tracked geolocation, identifying where the baggage item should be based on travel through the system or to a particular destination.

It will be appreciated that although the respective processes and associated processing modules are described as separate embodiments, aspects of the described embodiments can be combined to form further embodiments. For example, as discussed above, alternative embodiments may comprise one or more of the virtual tag registration and object identification and verification aspects described in the above embodiments.

As yet another alternative, the virtual tag registration and object-based verification modules may be provided as one or more distributed computing modules or processing services on a remote server that is in communication with the operator device and baggage tracking system via the data network. Additionally, as those skilled in the art will appreciate, the virtual tag registration module and object-based verification module functionality may be provided as one or more application programming interface (API) accessible by an application program executing on the operator device and baggage tracking system, or as a plug-in module, extension, embedded code, etc., configured to communicate with an application program.

Reference in this specification to “one embodiment” are not necessarily all referring to the same embodiment, nor are separate or alternative embodiments mutually exclusive of other embodiments. In particular, it will be appreciated that aspects of the above described embodiments can be combined to form further embodiments. Similarly, various features are described which may be exhibited by some embodiments and not by others. Yet further alternative embodiments may be envisaged, which nevertheless fall within the scope of the following claims.

Alternative embodiments are set out in the following examples:

1. A computer-implemented identity verification method comprising a computing device performing the steps of:

receiving, from a server, a challenge message associated with a baggage item;

outputting, by an augmented or mixed reality user interface of the computing device in response to receiving the challenge message, a prompt to respond to the challenge using the baggage item;

receiving, by the augmented or mixed reality user interface, a user's response to the challenge message, the response identifying a user-defined location on the baggage item;

generating a response to the challenge message based on the identified location; and

transmitting the response to the server, whereby a result is received from the server based on verification of the user-defined location communicated via the challenge response.

2. The method of example 1, wherein receiving the user's response to the challenge message comprises capturing an image of the baggage item, and augmenting the captured image of the baggage item with image data of the virtual tag at the user-defined location.
3. The method of example 1, wherein receiving the user's response to the challenge message comprises outputting an image of the baggage item and receiving user input defining a location on the output image.
4. The method of any preceding example, wherein the response is computed from the challenge message and the location identified in the user's response using a predefined algorithm.
5. The method of example 4, wherein the predefined algorithm includes computing a digital signature and/or hash value from the challenge message and the identified location.
6. The method of any preceding example, wherein the user-defined location is a 3D coordinate or region defined relative to a model of the baggage item.
7. The method of example 6, wherein the location is defined on the surface of, or within, the baggage item.
8. The method of any preceding example, further comprising registering, with the server, a virtual tag associated with the baggage item, the virtual tag including a unique data signature of the baggage item linked to the user-defined location on the baggage item.
9. The method of example 8, wherein the virtual tag is associated with a unique license plate identifier linking the virtual tag and the user-defined location to a passenger identifier.
10. The method of example 8 or 9, wherein the unique data signature is computed based at least on measurable properties of the baggage item detected in captured image data.
11. The method of example 10, wherein the measurable properties comprise one or more of physical parameters of the detected baggage item including shape, size, dimensions, and volume.
12. The method of example 11, wherein the measurable properties further comprise one or more of visible characteristics of the detected baggage item including colour, pattern, surface decoration, adornments, materials, damage, deformities, and baggage feature locations.
13. The method of example 11 or 12, wherein the unique data signature is computed from the values of the measurable properties using a predefined algorithm.
14. The method of example 13, wherein the predefined algorithm includes computing a unique hash value from the values of the measurable properties.
15. The method of any preceding example, further comprising supplementing the unique data signature with additional captured data associated with the baggage item.
16. The method of example 15, wherein the additional captured data comprises one or more of additional parameters of the detected baggage item captured by one or more scanning devices in the baggage handling system including weight, centre of gravity, density, x-ray imaging parameters, microdots, vibration signature, sonar response, moisture, odour intensity or composition, and/or radiation.
17. The method of any preceding example, wherein the visible characteristics and/or captured data comprises a time stamp indicative of temporal changes to the one or more parameters of the detected baggage item.
18. A computer-implemented identity verification method, comprising a server performing the steps of:

storing data associated with a baggage item, the stored data including a user-defined location on the baggage item;

transmitting, to a computing device, a challenge message associated with a baggage item;

receiving, from the computing device, a response to the challenge message generated based on a user input location on the baggage item;

verifying the user input location communicated via the challenge response; and

transmitting, to the computing device, a result of the verification.

19. The method of example 18, wherein the challenge response is computed from the challenge message and the user input location using a predefined algorithm, and wherein the user input location on the baggage item is input via an augmented or mixed reality user interface of the computing device that augments captured image of the baggage item with image data of the virtual tag at the user input location.
20. The method of example 19, wherein the verification comprises comparing the challenge response to a verification value computed from the challenge message and the user defined location using the predefined algorithm.
21. The method of example 20, wherein the predefined algorithm includes computing a digital signature and/or hash value.
22. A computer-implemented method for identifying an object in a baggage handling system, the method comprising:

capturing, by a computing device, an image of the object;

performing, by the computing device, image processing to detect the object in the captured image;

determining, by the computing device, a data signature of the detected object;

retrieving data defining a virtual tag associated with the determined data signature, the virtual tag including a defined location on the object;

determining that the defined location in the retrieved virtual tag is visible in the captured image;

augmenting, responsive to the determining, the captured image of the object with image data of the virtual tag at the defined location; and

displaying the augmented image, whereby the virtual tag is rendered for interrogation.

23. A method for registering a virtual tag of a baggage item in a baggage handling system, comprising a computing device performing the steps of:

computing a first unique data signature based on at least one measurable property of a baggage item detected in captured image data;

outputting a prompt, to an operator of the device, to modify the physical appearance of the baggage item in response to a determination that the first unique data signature is similar to one of a plurality of stored unique data signatures of other baggage items in the system;

computing a second unique data signature based on at least one measurable property of a modified baggage item detected from subsequent captured image data;

transmitting, to a server, data defining a unique virtual tag of the baggage item, the unique virtual tag including the second unique data signature; and

receiving, from the server, a message confirming the system is updated with the unique virtual tag.

24. The method of example 23, further comprising calculating a uniqueness value based on a comparison of the unique data signature of the detected baggage item to the plurality of stored unique data signatures of other baggage items in the system.
25. The method of example 24, further comprising determining that the calculated uniqueness index is below a threshold value of uniqueness.
26. The method of example 24 or 25, wherein the server determines that the unique data signature is similar to one of a plurality of stored unique data signatures of other baggage items in the system, the method further comprising receiving, by the computing device, the result of the determination from the server.
27. The method of any one of examples 23 to 26, further comprising capturing, by a camera of the computing device, the image data of the baggage item during a virtual tag registration process.
28. The method of example 27, further comprising:
receiving, by an augmented or mixed reality user interface of the computing device, user input defining a location relative to the baggage item detected in the image data.
29. The method of example 28, wherein the user-defined location is a 3D coordinate or region defined relative to a digital model of the baggage item.
30. The method of example 28 or 29, wherein the location is defined on the surface of, or within, the baggage item.
31. The method of any one of examples 28 to 39, wherein the virtual tag is associated with a unique license plate identifier linking the virtual tag and the user-defined location to a passenger identifier.
32. The method of any one of examples 28 to 31, further comprising receiving user input verification of the defined location, and in response, updating a tracked location of the baggage item in the baggage handling system.
33. The method of example 32, wherein user input verification of the defined location is received in response to processing a challenge message from the server.
34. The method of any one of examples 23 to 33, wherein the measurable properties comprise one or more of physical parameters of the detected baggage item including shape, size, dimensions, and volume.
35. The method of example 34, wherein the measurable properties further comprise one or more of visible characteristics of the detected baggage item including colour, pattern, surface decoration, adornments, materials, damage, deformities, and baggage feature locations.
36. The method of example 34 or 35, wherein the unique data signature is computed from the values of the measurable properties using a predefined algorithm.
37. The method of example 36, wherein the predefined algorithm includes computing a unique hash value from the values of the measurable properties.
38. The method of any preceding example, wherein the prompt comprises a visible, audible and/or haptic notification.
39. The method of any one of examples 23 to 37, wherein the measurable properties of the modified baggage item includes visible characteristics of one or more further surface decorations and/or adornments of the detected modified baggage item.
40. The method of any one of examples 23 to 39, further comprising supplementing the unique data signature of the virtual tag with additional captured data associated with the baggage item.
41. The method of example 40, wherein the additional captured data comprises one or more of additional parameters of the detected baggage item captured by one or more scanning devices in the baggage handling system including weight, centre of gravity, density, x-ray imaging parameters, microdots, vibration signature, sonar response, moisture, and/or radiation.
42. The method of any one of examples 23 to 41, wherein the visible characteristics and/or captured data comprises a time stamp indicative of temporal changes to the one or more parameters of the detected baggage item.
43. A method for registering a virtual tag of a baggage item in a baggage handling system, comprising a server of the system performing the steps of:

receiving, from a computing device, a first data signature based at least on measurable properties of a baggage item detected in captured image data;

determining that the first data signature is similar to one of a plurality of stored data signatures of other baggage items in the system;

transmitting, to the computing device, a result of the determination;

receiving, from the computing device, data defining a unique virtual tag of the baggage item, the unique virtual tag including a second data signature based at least on measurable properties of a modified baggage item detected from subsequent captured image data; and

updating the baggage handling system with the unique virtual tag of the baggage item.

44. The method of example 43, further comprising receiving data identifying a user-defined location relative to the baggage item and updating the unique virtual tag with the user-defined location.
45. The method of example 44, further comprising transmitting a challenge message to the computing device, verifying a challenge-response from the computing device encoding the user-defined location of the baggage item, and in response, updating a tracked location of the baggage item in the baggage handling system.
46. A system comprising means for performing the method of any one of examples 1 to 45.
47. A storage medium comprising machine readable instructions stored thereon for causing a computer system to perform a method in accordance with any one of examples 1 to 45.

1.-24. (canceled)

25. A computer-implemented identity verification method comprising a computing device performing the steps of:
receiving, from a server, a challenge message associated with a baggage item;
outputting, by an augmented or mixed reality user interface of the computing device in response to receiving the challenge message, a prompt to respond to the challenge using the baggage item;
receiving, by the augmented or mixed reality user interface, a user's response to the challenge message, the response identifying a user-defined location on the baggage item;
generating a response to the challenge message based on the identified location; and
transmitting the response to the server, whereby a result is received from the server based on verification of the user-defined location communicated via the challenge response.

26. The method of claim 25, wherein receiving the user's response to the challenge message comprises capturing an image of the baggage item, and augmenting the captured image of the baggage item with image data of the virtual tag at the user-defined location.

27. The method of claim 25, wherein receiving the user's response to the challenge message comprises outputting an image of the baggage item and receiving user input defining a location on the output image.

28. The method of claim 25, wherein the response is computed from the challenge message and the location identified in the user's response using a predefined algorithm.

29. The method of claim 25, wherein the user-defined location is a 3D coordinate or region defined relative to a model of the baggage item.

30. The method of claim 29, wherein the location is defined on the surface of, or within, the baggage item.

31. The method of claim 25, further comprising registering, with the server, a virtual tag associated with the baggage item, the virtual tag including a unique data signature of the baggage item linked to the user-defined location on the baggage item.

32. The method of claim 31, wherein the virtual tag is associated with a unique license plate identifier linking the virtual tag and the user-defined location to a passenger identifier.

33. The method of claim 31, wherein the unique data signature is computed based at least on measurable properties of the baggage item detected in captured image data.

34. The method of claim 33, wherein the measurable properties comprise one or more of physical parameters of the detected baggage item including shape, size, dimensions, and volume.

35. The method of claim 34, wherein the measurable properties further comprise one or more of visible characteristics of the detected baggage item including colour, pattern, surface decoration, adornments, materials, damage, deformities, and baggage feature locations.

36. The method of claim 34, wherein the unique data signature is computed from the values of the measurable properties using a predefined algorithm.

37. The method of claim 36, wherein the predefined algorithm includes computing a unique hash value from the values of the measurable properties.

38. The method of claim 25, further comprising supplementing the unique data signature with additional captured data associated with the baggage item.

39. The method of claim 38, wherein the additional captured data comprises one or more of additional parameters of the detected baggage item captured by one or more scanning devices in the baggage handling system including weight, centre of gravity, density, x-ray imaging parameters, microdots, vibration signature, sonar response, moisture, odour intensity or composition, and/or radiation.

40. The method of claim 25, wherein the visible characteristics and/or captured data comprises a time stamp indicative of temporal changes to the one or more parameters of the detected baggage item.

41. A computer-implemented identity verification method, comprising a server performing the steps of:
storing data associated with a baggage item, the stored data including a user-defined location on the baggage item;
transmitting, to a computing device, a challenge message associated with a baggage item;
receiving, from the computing device, a response to the challenge message generated based on a user input location on the baggage item;
verifying the user input location communicated via the challenge response; and
transmitting, to the computing device, a result of the verification.

42. The method of claim 41, wherein the challenge response is computed from the challenge message and the user input location using a predefined algorithm, and wherein the user input location on the baggage item is input via an augmented or mixed reality user interface of the computing device that augments captured image of the baggage item with image data of the virtual tag at the user input location.

43. The method of claim 42, wherein the verification comprises comparing the challenge response to a verification value computed from the challenge message and the user defined location using the predefined algorithm.

44. A system for computer-implemented identity verification comprising:
a computing device configured to:
receive, from a server, a challenge message associated with a baggage item;
output, by an augmented or mixed reality user interface of the computing device in response to receiving the challenge message, a prompt to respond to the challenge using the baggage item;
receive, by the augmented or mixed reality user interface, a user's response to the challenge message, the response identifying a user-defined location on the baggage item;
generate a response to the challenge message based on the identified location; and
transmit the response to the server, whereby a result is received from the server based on verification of the user-defined location communicated via the challenge response; and
a server configured to:
store data associated with the baggage item, the stored data including the user-defined location on the baggage item;
transmit, to the computing device, the challenge message associated with the baggage item;
receive, from the computing device, the response to the challenge message generated based on the user-defined location on the baggage item;
verify the user-defined location on the baggage item communicated via the challenge response; and
transmit, to the computing device, the result of the verification.
